(19) United States
(12) Patent Application Publication
(10) Pub. No.: US 2019/0360545 A1
(43) Pub. Date: Nov. 28, 2019

(54) SHOCK-ABSORBING DEVICE AND PACKAGE THEREOF

(71) Applicant: FIVETECH TECHNOLOGY INC., New Taipei City (TW)

(72) Inventors: TING-JUI WANG, NEW TAIPEI CITY (TW); Pei-Hsun Lin, New Taipei City (TW)

(21) Appl. No.: 16/532,527

(22) Filed: Aug. 6, 2019

Related U.S. Application Data
(62) Division of application No. 15/651,830, filed on Jul. 17, 2017.

(30) Foreign Application Priority Data
Jul. 20, 2016 (TW) 105210945

(51) Int. Cl. F16F 1/00; B65D 85/30; F16F 15/04; F16F 3/00; B65D 81/05; F16F 1/12

(52) U.S. Cl. CPC F16F 1/00; B65D 85/30; F16F 15/04; F16F 1/04; B65D 81/05; F16F 1/128; F16F 3/00

(57) ABSTRACT

A shock-absorbing device includes a first holding member, a second holding member movably assembled to the first holding member, and an elastic element disposed between the first and the second holding member with two ends of the elastic element pressing against the two holding members. With the elastic element, an elastic shock-absorbing space is defined between the first and the second holding member.

### CROSS-REFERENCE TO RELATED APPLICATION

This application is a divisional patent application of U.S. application Ser. No. 15/651,830 filed on Jul. 17, 2017, the entire contents of which are hereby incorporated by reference for which priority is claimed under 35 U.S.C. § 120.

### BACKGROUND OF THE INVENTION

### 1. Field of the Invention

The present invention relates to a shock-absorbing device and a package thereof; and more particularly, to a shock-absorbing device that protects external elements connected thereto against excessive vibration and a shock-absorbing device package, with which a plurality of shock-absorbing devices can be conveniently packed and stored in an organized manner.

### 2. Description of the Related Art

A printed circuit board plays a very important role in an electronic produce, because various kinds of high-precision electronic elements and circuits are provided on the printed circuit board. Generally, most electronic products having high-precision electronic elements are vulnerable to impact or collision. In the event an electronic product is unexpectedly subjected to an impact, the printed circuit board in the electronic product might be fiercely vibrated to cause damage to the electronic elements on the printed circuit board.

It is therefore desirable to develop a device that can prevent, for example, a printed circuit board from excessive vibration under an external force.

### BRIEF SUMMARY OF THE INVENTION

A primary object of the present invention is to overcome the disadvantage in the prior art electronic products by providing a shock-absorbing device that can protect an electronic element, such as a printed circuit board, against damage due to excessive vibration under an external force.

To achieve the above and other objects, the shock-absorbing device according to the present invention includes a first holding member; a second holding member movably assembled to the first holding member; and an elastic element disposed between the first and the second holding member with two ends of the elastic element pressing against the first and the second holding member, such that an elastic shock-absorbing space is defined between the first and the second holding member by the elastic element.

In an embodiment of the present invention, the elastic shock-absorbing space has a height ranged from 0.1 to 500 mm.

In an embodiment of the present invention, the first holding member is connected to a first external element by way of snap-fit, soldering, surface-mount technology (SMT), riveting, glue bonding, fastening, screwing or expanded connection; or the second holding member is connected to a second external element by way of snap-fit, soldering, SMT, riveting, glue bonding, fastening, screwing or expanded connection.

In an embodiment of the present invention, the first holding member includes a first receiving seat; a first connecting section extended from the first receiving seat and configured for connecting to a first external element; and a first coupling section formed on the first receiving seat and configured for movably coupling with the second holding member.

In an embodiment of the present invention, the second holding member includes a second receiving seat; a second connecting section extended from the second receiving seat and configured for connecting to a second external element; and a second coupling section formed around the second receiving seat and configured for movably coupling with the first coupling section.

In an embodiment of the present invention, the first coupling section includes a radially inward extended flange and the second coupling section includes a radially outward extended flange. The radially inward extended flange of the first coupling section is movably coupled with the radially outward extended flange of the second coupling section.

In an embodiment of the present invention, the second receiving seat further includes a locating boss; and the locating boss is formed on a bottom of the second receiving seat to locate the elastic element in place.

In an embodiment of the present invention, the first holding member includes a first receiving seat; a first connecting section extended from the first receiving seat and configured for connecting to a first external element; and a first coupling section centered in the first receiving seat and configured for movably coupling with the second holding member.

In an embodiment of the present invention, the second holding member includes a second receiving seat; a second connecting section extended from the second receiving seat and configured for connecting to a second external element; and a second coupling section formed on the second receiving seat and configured for movably coupling with the first coupling section.

In an embodiment of the present invention, the first coupling section includes a radially outward extended flange and the second coupling section includes a radially inward extended flange. The radially outward extended flange of the first coupling section is movably coupled with the radially inward extended flange of the second coupling section.

In an embodiment of the present invention, the first holding member includes a first seat; a first connecting section extended from the first seat and configured for connecting to a first external element; and a first coupling section formed around the first seat and configured for movably coupling with the second holding member.

In another embodiment of the present invention, the second holding member includes a second receiving seat; a second connecting section extended from the second receiving seat and configured for connecting to a second external element; and a second coupling section formed on the second receiving seat and configured for movably coupling with the first coupling section.

In another embodiment of the present invention, the first holding member and the second holding member are movably assembled to each other via a limiting element.

In another embodiment of the present invention, the limiting element is movably extended through one of the first holding member and the second holding member while being fastened to the other one of the first and the second holding member.

In another embodiment of the present invention, the first coupling section includes a radially outward extended flange and the second coupling section includes a radially inward extended flange. The radially outward extended flange of the first coupling section is movably coupled with the radially inward extended flange of the second coupling section.

In another embodiment of the present invention, the first holding member includes a first receiving seat; a first connecting section extended from the first receiving seat and configured for connecting to a first external element; and a first coupling section formed on the first receiving seat and configured for movably coupling with the second holding member.

In another embodiment of the present invention, the second holding member includes a second seat; a second connecting section extended from the second seat and configured for connecting to a second external element; and a second coupling section formed around the second seat and configured for movably coupling with the first coupling section.

In another embodiment of the present invention, the first coupling section includes a radially inward extended flange and the second coupling section includes a radially outward extended flange. The radially inward extended flange of the first coupling section is movably coupled with the radially outward extended flange of the second coupling section.

In an embodiment of the present invention, the first holding member is integrally formed with a first external element or the first holding member is combined with a first external element through assembly molding; or alternatively, the second holding member is integrally formed with a second external element or the second holding member is combined with a second external element through assembly molding.

In an embodiment of the present invention, the first or the second holding member is made of a metal material or a plastic material.

In an embodiment of the present invention, the first connecting section of the first holding member is a boss, a recess, a female thread, a male thread, a bevel surface, a cambered surface, a through hole, a notch or a curved surface.

In an embodiment of the present invention, the first connecting section of the first holding member has a stepped outer surface.

In an embodiment of the present invention, the first connecting section of the first holding member is in the form of a sunken hole or a through hole.

In an embodiment of the present invention, either the sunken hole or the through hole has female threads formed on an inner wall surface thereof.

In an embodiment of the present invention, either the sunken hole or the through hole has a protrusion and a notch correspondingly provided on an inner wall surface thereof.

In an embodiment of the present invention, the second connecting section of the second holding member is a boss, a recess, a female thread, a male thread, a bevel surface, a cambered surface, a through hole, a notch or a curved surface.

In an embodiment of the present invention, the second connecting section of the second holding member has a stepped outer surface.

In an embodiment of the present invention, the second connecting section of the second holding member is a sunken hole or a through hole. Either the sunken hole or the through hole has female threads formed on an inner wall surface thereof.

In an embodiment of the present invention, the elastic element is a compression spring, a helical spring, a torsion spring, an elastic washer, a bent spring strip, a flat spring or an elastic bar.

In an embodiment of the present invention, the first receiving seat has a first receiving space for receiving the elastic element therein and movably receiving the second holding member therein.

In an embodiment of the present invention, the second receiving seat has a second receiving space for receiving the elastic element therein and movably receiving the first holding member therein.

In an embodiment of the present invention, the first holding member has a first anti-rotation section for interfering with or engaging with a first external element, or the second holding member has a second anti-rotation section for interfering with or engaging with a second external element.

In an embodiment of the present invention, the first anti-rotation section is in the form of a tangential surface, a cut edge, multiple tangential surfaces, multiple cut edges, a hexagon, an octagon, a cambered surface, a polygon, a spherical surface, a curved surface, a protrusion or a recess; or, the second anti-rotation section is in the form of a tangential surface, a cut edge, multiple tangential surfaces, multiple cut edges, a hexagon, an octagon, a cambered surface, a polygon, a spherical surface, a curved surface, a protrusion or a recess.

In an embodiment of the present invention, the first anti-rotation section can be provided on an upper side, a lower side, a lateral side, an inner side or an outer side of the first holding member; or, the second anti-rotation section can be provided on an upper side, a lower side, a lateral side, an inner side or an outer side of the second holding member.

In an embodiment of the present invention, the first holding member has a third anti-rotation section; or, the second holding member has a fourth anti-rotation section. The third and the fourth anti-rotation section are movably engaged with or interfered with each other.

In an embodiment of the present invention, the first holding member has a third anti-rotation section and the second holding member has a fourth anti-rotation section. The third and the fourth anti-rotation section are movably engaged with or interfered with each other to prevent the first holding member and the second holding member from rotating relative to each other.

In an embodiment of the present invention, the third anti-rotation section is in the form of a tangential surface, a cut edge, multiple tangential surfaces, multiple cut edges, a hexagon, an octagon, a cambered surface, a polygon, a spherical surface, a curved surface, a protrusion or a recess; or, the fourth anti-rotation section is in the form of a tangential surface, a cut edge, multiple tangential surfaces, multiple cut edges, a hexagon, an octagon, a cambered surface, a polygon, a spherical surface, a curved surface, a protrusion or a recess.

In an embodiment of the present invention, the third anti-rotation section can be provided on an upper side, a lower side, a lateral side, an inner side or an outer side of the first holding member; or, the fourth anti-rotation section can be provided on an upper side, a lower side, a lateral side, an inner side or an outer side of the second holding member.

In an embodiment of the present invention, a top or a bottom of the first holding member can be fully closed, be provided with a through hole, or be provided with a recess; or, a top or a bottom of the second holding member can be fully closed, be provided with a through hole, or be provided with a recess.

In an embodiment of the present invention, the first holding member and the second holding member are spaced from each other by a distance ranged from 0 to 550 mm.

Another object of the present invention is to provide a shock-absorbing device package, which includes a device carrier and at least one shock-absorbing device described above. The device carrier includes a main body and at least one compartment; and the at least one compartment is a recess formed on the main body for holding the at least one shock-absorbing device therein.

In an embodiment of the present invention, the main body of the device carrier is in the form of a long belt or a tray.

In an embodiment of the present invention, the shock-absorbing device package further includes a cover configured for covering onto the at least one compartment.

In an embodiment of the present invention, the elastic element has shock-absorbing elasticity ranged from 10 to 100,000 grams.

In an embodiment of the present invention, the first holding member or the second holding member is provided with at least one receiving section for receiving the elastic element therein.

In an embodiment of the present invention, the first receiving seat is provided with at least one receiving section or a plurality of receiving sections for receiving the elastic element therein. The receiving section is in the form of a sunken area, a recess, a slot or a through hole.

In an embodiment of the present invention, the second receiving seat is provided with at least one receiving section or a plurality of receiving sections for receiving the elastic element therein. The receiving section is in the form of a sunken area, a recess, a slot or a through hole.

In an embodiment of the present invention, the receiving sections are spaced near an outer periphery of the second coupling section, and the receiving sections are in the form of a sunken area, a recess, a slot or a through hole.

In an embodiment of the present invention, the first and the second holding member have at least one or a plurality of elastic elements disposed between them.

In an embodiment of the present invention, the first coupling section includes a fastening section.

In an embodiment of the present invention, the fastening section is in the form of a male thread, a female thread, a post, a male retainer or a female retainer.

In an embodiment of the present invention, the first holding member includes a first receiving seat, a first connecting section and a first coupling section. The first receiving seat has a first receiving space, and the first coupling section is centered in the first receiving seat.

In an embodiment of the present invention, the second holding member includes a second receiving seat, a second connecting section and a second coupling section. The second receiving seat has a second receiving space and a receiving chamber, the first coupling section is extended through the receiving chamber and the second receiving space, and the elastic element is fitted around the first coupling section and received in the receiving chamber.

In an embodiment of the present invention, the second holding member includes a second receiving seat, a second connecting section and a second coupling section. The second receiving seat has a second receiving space and at least one receiving chamber, the first coupling section is extended through the second receiving space, and the elastic element is received in the receiving chamber.

In an embodiment of the present invention, the first holding member and the second holding member are integrally formed with the first external element and the second external element, respectively.

With the first holding member, the second holding member and the elastic element(s), the shock-absorbing device of the present invention functions to protect the first and the second external element against excessive vibration when they are subjected to an external force.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a sectional view showing the shock-absorbing device according to an embodiment of the present invention for fitting between a first and a second external element.

FIG. 2 is a sectional view showing the shock-absorbing device according to an embodiment of the present invention for fitting between a first and a second external element.

FIG. 3 is a sectional view showing the shock-absorbing device according to an embodiment of the present invention for fitting between a first and a second external element.

FIG. 4A is a sectional view showing the shock-absorbing device according to an embodiment of the present invention for fitting between a first and a second external element.

FIG. 4B is a sectional view showing the shock-absorbing device according to an embodiment of the present invention for fitting between a first and a second external element.

FIG. 5 is a sectional view showing the shock-absorbing device according to an embodiment of the present invention for fitting between a first and a second external element.

FIG. 6 is a sectional view showing the shock-absorbing device according to an embodiment of the present invention for fitting between a first and a second external element.

FIG. 7 is a sectional view showing the shock-absorbing device according to an embodiment of the present invention for fitting between a first and a second external element.

FIG. 8 is a sectional view showing the shock-absorbing device according to an embodiment of the present invention for fitting between a first and a second external element.

FIG. 9 is a sectional view showing the shock-absorbing device according to an embodiment of the present invention for fitting between a first and a second external element.

FIG. 10 is a sectional view showing the shock-absorbing device according to an embodiment of the present invention for fitting between a first and a second external element.

FIG. 11A is a sectional view showing the shock-absorbing device of the present invention in a non-compressed state between the first and the second external elements.

FIG. 11B is a sectional view showing the shock-absorbing device of the present invention in a compressed state between the first and the second external elements.

FIG. 12 is a fragmentary sectional view of the shock-absorbing device package according to an embodiment of the present invention.

FIG. 13 is a sectional view of the shock-absorbing device according to a further embodiment of the present invention.

FIG. 14 is a top view of a second holding member of the shock-absorbing device of FIG. 13.

FIG. 15 is a sectional view of the shock-absorbing device according to a still further embodiment of the present invention.

FIG. 16 shows some different configurations for a fastening section of the shock-absorbing device of FIG. 15.

### DETAILED DESCRIPTION OF THE INVENTION

The present invention will now be described with some preferred embodiments thereof and by referring to the accompanying drawings. For the purpose of easy to understand, elements that are the same in the preferred embodiments are denoted by the same reference numerals.

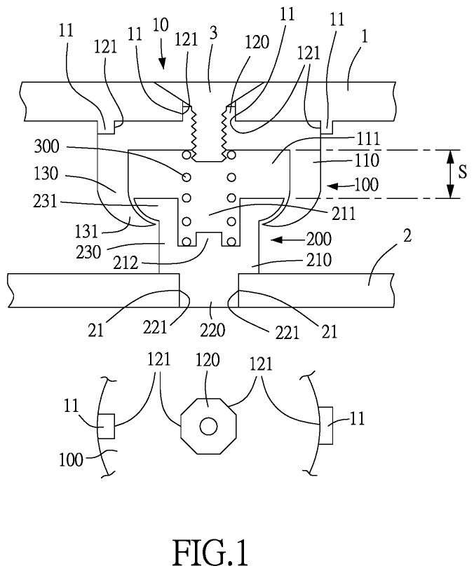

Please refer to FIGS. 1 through 10, which are sectional views showing shock-absorbing devices 10-80 according to various embodiments of the present invention for fitting between a first external element 1 and a second external element 2. A lower portion of FIG. 1 is a fragmentary top view of a first holding member 100 of the shock-absorbing device 10 in the first embodiment. To clearly show a relation between a first anti-rotation section 121 on the first holding member 100 and a first mating anti-rotation section 11 on the first external element 1, the first and second external elements 1, 2, a screw 3 for connecting the first external element 1 to the first holding member 100, and a second holding member 200 of the shock-absorbing device 10 are emitted from the lower portion of FIG. 1. Further, a second anti-rotation section 221 on the second holding member and a second mating anti-rotation section 21 on the second external element 2 work in the same manner as the first anti-rotation section 121 and the first mating anti-rotation section 11. The shock-absorbing device 10 is configured for fitting between the first and second external elements 1, 2, which can be printed circuit boards, plastic members or metal members.

As can be seen in FIG. 1, the shock-absorbing device 10 includes a first holding member 100, a second holding member 200, and an elastic element 300.

The first holding member 100 is configured for connecting to the first external element 1. In the first embodiment, the first holding member 100 includes a first receiving seat 110, a first connecting section 120, and a first coupling section 130. The first holding member 100 can have a first anti-rotation section 121 for engaging with a first mating anti-rotation section 11 on the first external element 1 to prevent the first holding member 100 and the first external element 1 from rotating relative to each other. The first anti-rotation section 121 can be in the form of a tangential surface, a recess, a cut edge, a cambered surface, a polygon, a spherical surface, a curved surface, a protrusion, or a sunken area. The first mating anti-rotation section 11 is a complementary structure of the first anti-rotation section 121. Further, the first anti-rotation section 121 can be provided on an upper side, a lateral side, an outer side, a lower side or an inner side of the first holding member 100.

The first receiving seat 110 has a first receiving space or hole 111 for receiving the elastic element 300 therein. Meanwhile, the second holding member 200 is movably received in the first receiving space 111.

The first connecting section 120 is extended from the first receiving seat 110 and configured for connecting to the first external element 1. More specifically, in the first embodiment, the first connecting section 120 is locked to the first external element 1 by means of an externally provided screw 3. However, it is understood the first connecting section 120 can be connected to the first external element 1 in other ways, including but not limited to snap-fit, soldering, surface-mount technology (SMT), riveting, glue bonding, fastening or expanded connection. Further, the first connecting section 120 can be in the form of a boss, a recess, a female thread, a male thread, a bevel surface, a cambered surface, a through hole, a notch or a curved surface.

The first coupling section 130 is formed around the first receiving seat 110 and configured for movably coupling with the second holding member 200. In the first embodiment, the first coupling section 130 has a top formed into a radially inward extended flange 131.

The second holding member 200 is movably assembled to the first holding member 100 and configured for connecting to the second external element 2. In the first embodiment, the second holding member 200 includes a second receiving seat 210, a second connecting section 220 and a second coupling section 230. The second holding member 200 can have a second anti-rotation section 221 for engaging with a second mating anti-rotation section 21 on the second external element 2 to prevent the second holding member 200 and the second external element 2 from rotating relative to each other. The second anti-rotation section 221 can be in the form of a tangential surface, a recess, a cut edge, a cambered surface, a polygon, a spherical surface, a curved surface, a protrusion, or a sunken area. The second mating anti-rotation section 21 is a complementary structure of the second anti-rotation section 221. Further, the second anti-rotation section 221 can be provided on an upper side, a lateral side, an outer side, a lower side or an inner side of the second holding member 200.

The second receiving seat 210 has a second receiving space or hole 211 for receiving the elastic element 300 therein. In the first embodiment, the second receiving seat 210 further has a locating boss 212 formed on a bottom of the second receiving space 211 to locate the elastic element 300 in place.

The second connecting section 220 is extended from the second receiving seat 210 and configured for connecting to the second external element 2. More specifically, in the first embodiment, the second connecting section 220 is snap-fitted onto the second external element 2. However, it is understood the second connecting section 220 can be connected to the second external element 2 in other ways, including but not limited to soldering, SMT, riveting, glue bonding, fastening, screwing or expanded connection. Further, the second connecting section 220 can be in the form of a boss, a recess, a female thread, a male thread, a bevel surface, a cambered surface, a through hole, a notch or a curved surface.

The second coupling section 230 is formed around the second receiving seat 210 and configured for movably coupling with the first coupling section 130. In the first embodiment, the second coupling section 230 has a top formed into a radially outward extended flange 231. The radially inward extended flange 131 of the first coupling section 130 is movably coupled with the radially outward extended flange 231 of the second coupling section 230.

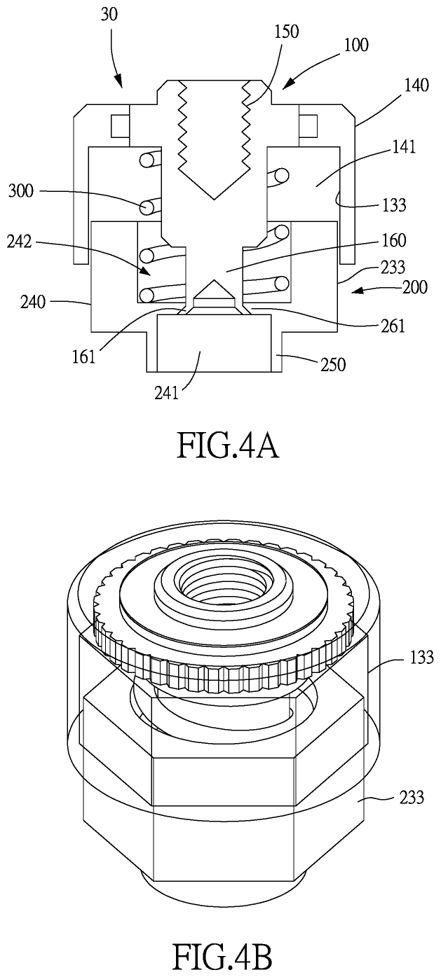

Please refer to FIG. 1 along with FIG. 4B. The first holding member 100 can have a third anti-rotation section 133, and the second holding member 200 can have a fourth anti-rotation section 233 configured for movably engaging with the third anti-rotation section 133, such that the first holding member 100 and the second holding member 200 are prevented from rotating relative to each other but are allowed to move axially relative to each other. The third and the fourth anti-rotation section 133, 233 are designed based on the same structural principle as the first mating anti-rotation section 11 and the first anti-rotation section 121 or as the second mating anti-rotation section 21 and the second anti-rotation section 221. Again, the third anti-rotation section 133 can be in the form of a tangential surface, a cut edge, a cambered surface, a polygon, a spherical surface, a curved surface, a protrusion or a recess; and similarly, the fourth anti-rotation section 233 can be in the form of a tangential surface, a cut edge, a cambered surface, a polygon, a spherical surface, a curved surface, a protrusion or a recess. Further, the third anti-rotation section 133 can be provided on an upper side, a lower side, a lateral side, an inner side or an outer side of the first holding member 100; and the fourth anti-rotation section 233 can be provided on an upper side, a lower side, a lateral side, an inner side or an outer side of the second holding member 200.

The elastic element 300 is a spring disposed between the first holding member 100 and the second holding member 200 with two ends of the spring pressing against the first and the second holding member 100, 200. The elastic element 300 has shock-absorbing elasticity ranged from 10 to 100,000 grams. Further, there is an elastic shock-absorbing space S defined between the first and the second holding member 100, 200. By “elastic shock-absorbing space S”, it means a maximum space within which the first holding member 100 and the second holding member 200 can move relative to each other. With the elastic force of the elastic element 300, the first holding member 100 and the second holding member 200 can be moved away from or closer to each other.

When the first external element 1 and the second external element 2 are subjected to an external force and vibrated, the shock-absorbing device 10 fitted between them provides a buffering effect to prevent the first and second external elements 1, 2 from being excessively vibrated.

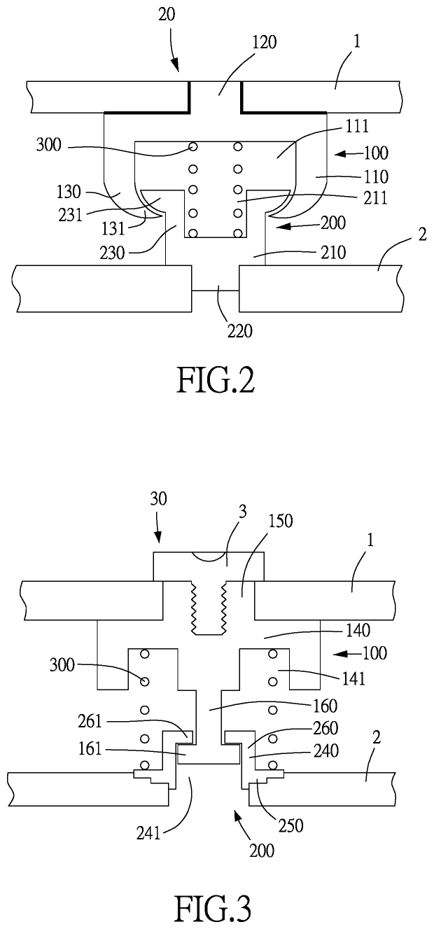

FIG. 2 is a sectional view of the shock-absorbing device 20 according to a second embodiment of the present invention. The shock-absorbing device 20 is generally structurally similar to the shock-absorbing device 10, except that the first connecting section 120 of the first holding member 100 of the shock-absorbing device 20 is connected to the first external element 1 by way of snap-fit and soldering. However, it is understood the first connecting section 120 can be connected to the first external element 1 in other ways, including but not limited to SMT, riveting, glue bonding, fastening or expanded connection. Further, the shock-absorbing device 20 is provided only with the second receiving space 211 for receiving the elastic element 300 therein.

Please refer to FIGS. 3, 4A and 4B. FIG. 3 is a sectional view of the shock-absorbing device 30 according to a third embodiment of the present invention. As shown, the shock-absorbing device 30 has a first holding member 100, which includes a first receiving seat 140, a first connecting section 150 and a first coupling section 160. FIGS. 4A and 4B are sectional and perspective views, respectively, of a first variation of the shock-absorbing device 30. The first variation of the shock-absorbing device 30 is technically characterized in further including a third anti-rotation section 133 and a fourth anti-rotation section 233. To clearly show this technical feature, only the reference numerals 133, 233 of the third anti-rotation section 133 and the fourth anti-rotation section 233, respectively, are shown FIG. 4B.

In the third embodiment, the first receiving seat 140 internally defines a first receiving space or hole 141 for receiving the elastic element 300 therein.

The first connecting section 150 is extended from the first receiving seat 140 and configured for connecting to the first external element 1. More specifically, in the third embodiment, the first connecting section 150 is locked to the first external element 1 by means of an externally provided screw 3. However, it is understood the first connecting section 150 can be connected to the first external element 1 in other ways, including but not limited to snap-fit, soldering, SMT, riveting, glue bonding, fastening or expanded connection.

The first coupling section 160 is centered in the first receiving seat 140 and configured for movably coupling with the second holding member 200. In the third embodiment, the first coupling section 160 has an end formed into a radially outward extended flange 161.

The second holding member 200 is movably assembled to the first holding member 100 and configured for connecting to the second external element 2. In the third embodiment, the second holding member 200 includes a second receiving seat 240, a second connecting section 250 and a second coupling section 260.

In the first variation of the shock-absorbing device 30 as shown in FIG. 4A, the second receiving seat 240 has a second receiving space or hole 241 and a receiving chamber 242, and the first coupling section 160 is extended through the receiving chamber 242 and the second receiving space 241.

The second connecting section 250 is extended from the second receiving seat 240 and configured for connecting to the second external element 2. More specifically, in the third embodiment, the second connecting section 250 is connected to the second external element 2 by expanded connection. However, it is understood the second connecting section 250 can be connected to the second external element 2 in other ways, including but not limited to snap-fit, soldering, SMT, riveting, glue bonding, fastening or screwing.

The second coupling section 260 is formed around the second receiving seat 240 and configured for movably coupling with the first coupling section 160. In the third embodiment, the second coupling section 260 has a radially inward extended flange 261 formed on a top (see FIG. 3) or on an inner side (see FIG. 4A) thereof. The radially outward extended flange 161 of the first coupling section 160 is movably coupled with the radially inward extended flange 261 of the second coupling section 260.

The elastic element 300 is a spring disposed between the first holding member 100 and the second holding member 200 with two ends of the spring pressing against the first and the second holding member 100, 200. Further, there is an elastic shock-absorbing space S defined between the first and the second holding member 100, 200. By “elastic shock-absorbing space S”, it means a maximum space within which the first holding member 100 and the second holding member 200 can move relative to each other. In the first variation of the shock-absorbing device 30 as shown in FIG. 4A, the elastic element 300 is fitted around the first coupling section 160 and received in the receiving chamber 242. With the elastic force of the elastic element 300, the first holding member 100 and the second holding member 200 can be moved away from or closer to each other.

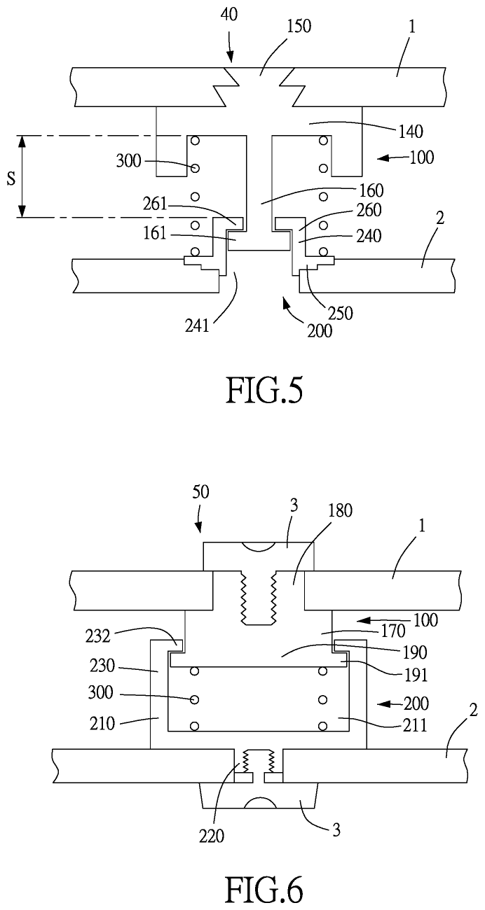

FIG. 5 is a sectional view of the shock-absorbing device 40 according to a fourth embodiment of the present invention. The shock-absorbing device 40 is generally structurally similar to the shock-absorbing device 30 shown in FIGS. 3, 4A and 4B, except that the first connecting section 150 of the first holding member 100 of the shock-absorbing device 40 has a stepped outer surface for connecting to the first external element 1 by way of snap-fit. However, it is understood the first connecting section 150 can be connected to the first external element 1 in other ways, including but not limited to soldering, SMT, riveting, glue bonding, fastening or expanded connection.

FIG. 6 is a sectional view of the shock-absorbing device 50 according to a fifth embodiment of the present invention. In the fifth embodiment, the shock-absorbing device 50 has a first holding member 100 that includes a first seat 170, a first connecting section 180 and a first coupling section 190.

The first connecting section 180 is extended from the first seat 170 and configured for connecting to the first external element 1. More specifically, the first connecting section 180 is locked to the first external element 1 by means of an externally provided screw 3. However, it is understood the first connecting section 180 can be connected to the first external element 1 in other ways, including but not limited to snap-fit, soldering, SMT, riveting, glue bonding, fastening or expanded connection.

The first coupling section 190 is formed around the first seat 170 and configured for movably coupling with the second holding member 200. In the fifth embodiment, the first coupling section 190 has a top formed into a radially outward extended flange 191.

The second holding member 200 is movably assembled to the first holding member 100 and configured for connecting to the second external element 2. In the fifth embodiment, the second holding member 200 includes a second receiving seat 210, a second connecting section 220 and a second coupling section 230.

The second receiving seat 210 has a second receiving space or hole 211 for receiving the elastic element 300 and the first coupling section 190 therein.

The second connecting section 220 is extended from the second receiving seat 210 and configured for connecting to the second external element 2. More specifically, the second connecting section 220 is locked to the second external element 2 by means of an externally provided screw 3. However, it is understood the second connecting section 220 can be connected to the second external element 2 in other ways, including but not limited to snap-fit, soldering, SMT, riveting, glue bonding, fastening or expanded connection.

The second coupling section 230 is formed around the second receiving seat 210 and configured for movably coupling with the first coupling section 190. In the fifth embodiment, the second coupling section 230 has a top formed into a radially inward extended flange 232. The radially outward extended flange 191 of the first coupling section 190 is movably coupled with the radially inward extended flange 232 of the second coupling section 230.

The elastic element 300 is a spring disposed between the first holding member 100 and the second holding member 200 with two ends of the spring pressing against the first and the second holding member 100, 200. Further, there is an elastic shock-absorbing space S defined between the first and the second holding member 100, 200. By “elastic shock-absorbing space S”, it means a maximum space within which the first holding member 100 and the second holding member 200 can move relative to each other. With the elastic force of the elastic element 300, the first holding member 100 and the second holding member 200 can be moved away from or closer to each other.

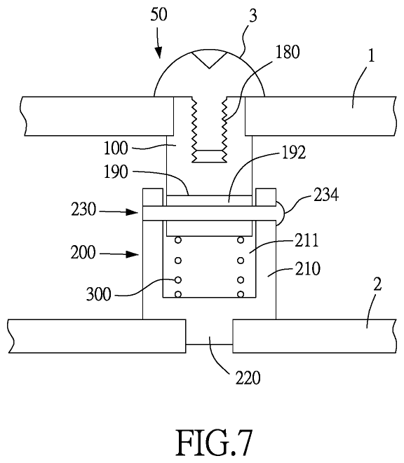

FIG. 7 shows a first variation of the shock-absorbing device 50 according to the fifth embodiment. Unlike the shock-absorbing device 50 of FIG. 6, the first holding member 100 and the second holding member 200 of the shock-absorbing device 50 of FIG. 7 are movably assembled to each other via a limiting element 234. The limiting element 234 can be a shaft that is movably extended through a loose hole 192 on the first holding member 100 and fastened to the second holding member 200. Alternatively, the limiting element 234 can be movably extended through a loose hole on the second holding member 200 and fixedly fastened to the first holding member 100.

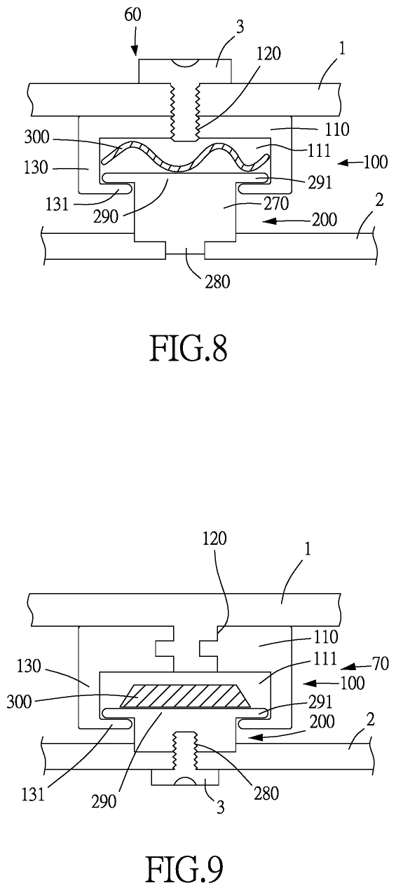

FIG. 8 is a sectional view of the shock-absorbing device 60 according to a sixth embodiment of the present invention. In the sixth embodiment, the first holding member 100 of the shock-absorbing device 60 includes a first receiving seat 110, a first connecting section 120 and a first coupling section 130.

The first receiving seat 110 has a first receiving space or hole 111 for receiving the elastic element 300 therein. Meanwhile, the second holding member 200 is movably received in the first receiving space 111.

The first connecting section 120 is extended from the first receiving seat 110 and configured for connecting to the first external element 1. More specifically, in the sixth embodiment, the first connecting section 120 is a sunken hole or a recess with female threads formed on an inner wall surface thereof and can therefore be connected to the first external element 1 by means of an externally provided screw 3. However, it is understood the first connecting section 120 can be connected to the first external element 1 in other ways, including but not limited to snap-fit, soldering, SMT, riveting, glue bonding, fastening or expanded connection.

The first coupling section 130 is formed around the first receiving seat 110 and configured for movably coupling with the second holding member 200. In the sixth embodiment, the first coupling section 130 has a top formed into a radially inward extended flange 131.

The second holding member 200 is movably assembled to the first holding member 100 and configured for connecting to the second external element 2. In the sixth embodiment, the second holding member 200 includes a second seat 270, a second connecting section 280 and a second coupling section 290.

The second connecting section 280 is extended from the second seat 270 and configured for connecting to the second external element 2. More specifically, in the sixth embodiment, the second connecting section 280 is a boss for connecting to the second external element 2 by way of snap-fit. However, it is understood the second connecting section 280 can be connected to the second external element 2 in other ways, including but not limited to soldering, SMT, riveting, glue bonding, fastening, expanded connection or screwing.

The second coupling section 290 is formed around the second seat 270 and configured for movably coupling with the first coupling section 130. In the sixth embodiment, the second coupling section 290 has a top formed into a radially outward extended flange 291. The radially inward extended flange 131 of the first coupling section 130 is movably coupled with the radially outward extended flange 291 of the second coupling section 290.

In the sixth embodiment, the elastic element 300 is a bent spring strip disposed between and pressed against the first holding member 100 and the second holding member 200. Further, there is an elastic shock-absorbing space S defined between the first and the second holding member 100, 200. By “elastic shock-absorbing space S”, it means a maximum space within which the first holding member 100 and the second holding member 200 can move relative to each other. With the elastic force of the elastic element 300, the first holding member 100 and the second holding member 200 can be moved away from or closer to each other.

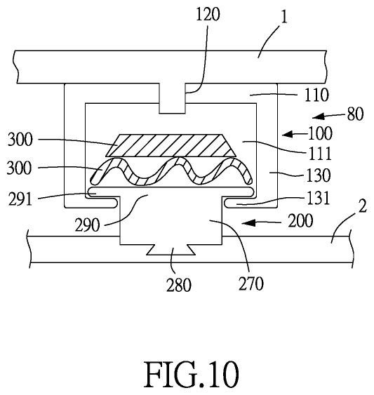

FIG. 9 is a sectional view of the shock-absorbing device 70 according to a seventh embodiment of the present invention. The shock-absorbing device 70 of FIG. 9 is generally structurally similar to the shock-absorbing device 60 of FIG. 8. However, unlike the shock-absorbing device 60, the first connecting section 120 of the first holding member 100 of the shock-absorbing device 70 is a sunken hole or a recess. A protrusion and a notch are correspondingly provided on two diametrically opposite sides of an inner wall surface of the sunken hole of the first connecting section 120 for connecting to the first external element 1 by way of snap-fit. However, it is understood the first connecting section 120 can be connected to the first external element 1 in other ways, including but not limited to soldering, SMT, riveting, glue bonding, fastening or expanded connection. Further, the elastic element 300 for the shock-absorbing device 70 is an elastic washer. The second connecting section 280 of the second holding member 200 of the shock-absorbing device 70 is a sunken hole or a recess with female threads formed on an inner wall surface thereof and can therefore be connected to the second external element 2 by means of an externally provided screw 3. However, it is understood the second connecting section 280 can be connected to the second external element 2 in other ways, including but not limited to soldering, SMT, riveting, glue bonding, fastening or expanded connection.

FIG. 10 is a sectional view of the shock-absorbing device 80 according to an eighth embodiment of the present invention. The shock-absorbing device 80 is generally structurally similar to the shock-absorbing device 70 of FIG. 9, except that the first connecting section 120 of the first holding member 100 of the shock-absorbing device 80 is a sunken hole or a recess for connecting to the first external element 1 by way of snap-fit. However, it is understood the first connecting section 120 can be connected to the first external element 1 in other ways, including but not limited to soldering, SMT, riveting, glue bonding, fastening or expanded connection. Further, unlike the shock-absorbing device 70, the second connecting section 280 of the second holding member 200 of the shock-absorbing device 80 has a stepped outer surface for connecting to the second external element 2 by way of snap-fit. However, it is understood the second connecting section 280 can be connected to the second external element 2 in other ways, including but not limited to soldering, SMT, riveting, glue bonding, fastening or expanded connection. Further, the elastic element 300 for the shock-absorbing device 80 is a combination of an elastic washer and a bent spring strip.

It is understood the above-described shock-absorbing devices 10-80 in the first to the eighth embodiment of the present invention are only illustrative. In other words, various combinations of the differently configured first holding members 100, second holding members 200 and elastic elements can be achieved to provide shock-absorbing devices of different configurations.

According to other operable embodiments of the present invention, the first holding member 100 of the shock-absorbing device 10-80 can be integrally formed with the first external element 1, and the second holding member 200 can be integrally formed with the second external element 2. Further, the first and the second holding member 100, 200 can be made of a metal material or a plastic material.

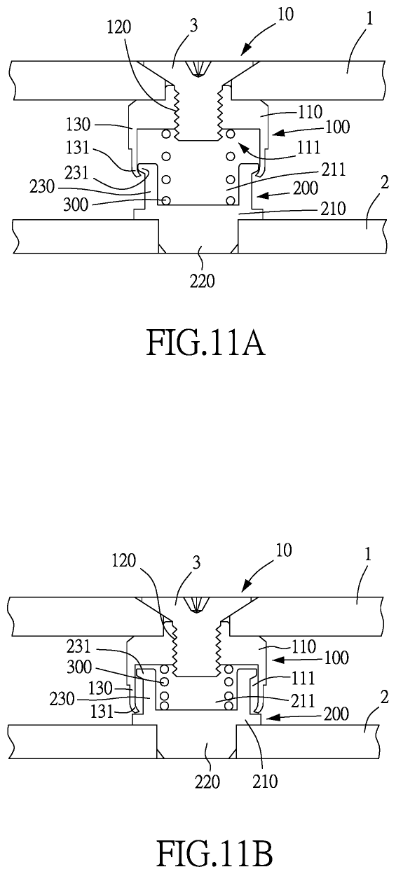

Please refer to FIGS. 11A and 11B, which are sectional views showing the shock-absorbing device of the present invention in anon-compressed and a compressed state, respectively, between the first and the second external elements 1, 2. It is noted the shock-absorbing device 10 of FIG. 1 is illustrated in FIGS. 11A and 11B as an example for explanation

When the first external element 1 and the second external element 2 are subjected to an external force and vibrated, the shock-absorbing device 10 fitted between them provides a buffering effect to prevent the first and second external elements 1, 2 from being excessively vibrated.

As can be seen in FIG. 11A, when the first and the second external element 1, 2 are not subjected to any external force, the elastic element 300 of the shock-absorbing device 10 is in a non-compressed state and pushes the first and the second external element 1, 2 away from each other.

On the other hand, as can be seen in FIG. 11B, when the first and the second external element 1, 2 are subjected to an external force, the elastic element 300 of the shock-absorbing device 10 goes into a compressed state and the first and the second external element 1, 2 are brought to move toward each other. In this manner, a buffering and shock-absorbing effect can be achieved to protect the first and second external elements 1, 2 against excessive vibration under an external force. In this case, a height of the elastic shock-absorbing space S is in the range of 0.1 to 500 mm.

In summary, the top or the bottom of the first holding member 100 can be fully closed, be provided with a through hole, or be provided with a recess. Alternatively, the top or the bottom of the second holding member 200 can be fully closed, be provided with a through hole, or be provided with a recess.

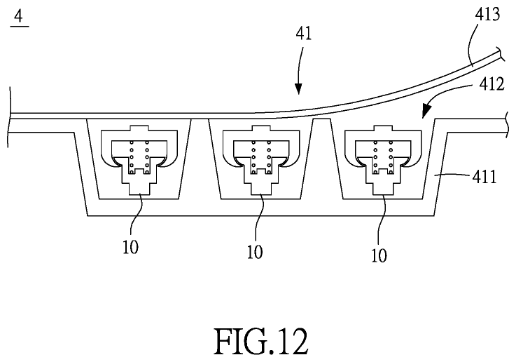

Please refer to FIG. 12, which is a fragmentary sectional view of a shock-absorbing device package 4 according to an embodiment of the present invention.

For the purpose of conciseness, the shock-absorbing device package 4 according to the present invention is herein also briefly referred to as the package 4. As shown, the package 4 includes a device carrier 41 and at least one shock-absorbing device 10-80 as described above. The device carrier 41 includes a main body 411, at least one compartment 412 and a cover 413. The at least one compartment 412 is a recess formed on the main body 411 for holding one shock-absorbing device 10-80 therein. In FIG. 12, there is shown a plurality of compartments 412 with one shock-absorbing device 10 held in each of the compartments 412. The cover 413 is configured for covering onto the at least one compartment 412, so that each shock-absorbing device 10-80 packed in the package 4 is sealed in one compartment 412.

The shock-absorbing devices 10-80 disposed in the compartments 412 of the device carrier 41 can be removed from the device carrier 41 with hands or with a tool, such as a vacuum picker or a magnetic claw picker, for connecting to the first external element 1 and the second external element 2.

In other operable embodiments, the device carrier 41 can be a long belt or a tray in shape. The long belt-shaped device carrier 41 can be wound into a roll for convenient storage in an organized manner. On the other hand, a plurality of tray-shaped device carriers 41 can be stacked for convenient storage.

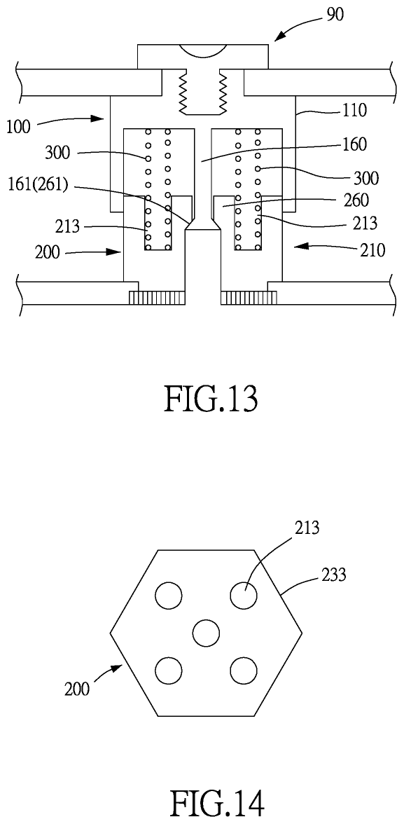

Please refer to FIGS. 13 and 14, wherein FIG. 13 is a sectional view of a shock-absorbing device 90 according to a ninth embodiment of the present invention and FIG. 14 is a top view of the second holding member 200 of the shock-absorbing device 90 of FIG. 13. As shown, in the shock-absorbing device 90, the first receiving seat 110 of the first holding member 100 or the second receiving seat 210 of the second holding member 200 is provided with at least one receiving section 213 for receiving the elastic element 300 therein. The receiving section 213 can be in the form of a sunken area, a recess, a slot or a through hole. In the illustrated ninth embodiment, there are four receiving sections 213 spaced near an outer periphery of the second coupling section 260 of the second receiving seat 210. It is understood the number of the receiving sections 213 can be two, three or more than four, depending on actual need in use. Each of the receiving sections 213 has one elastic element 300 received therein, so that there can be more than one elastic element 300 disposed between the first and the second holding member 100, 200. In the ninth embodiment, the radially outward extended flange 161 of the first coupling section 160 is movably coupled with the radially inward extended flange 261 of the second coupling section 260.

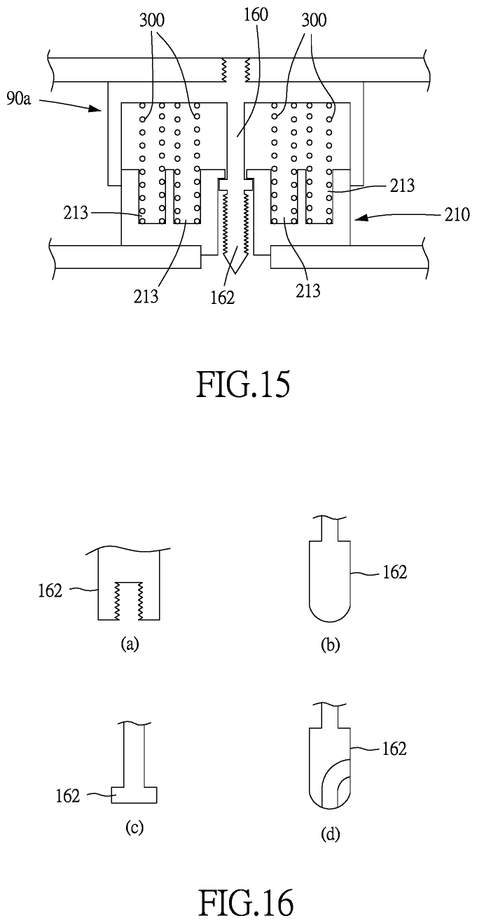

Please refer to FIGS. 15 and 16, wherein FIG. 15 is a sectional view of a shock-absorbing device 90a according to a tenth embodiment of the present invention and FIG. 16 shows some different configurations for a fastening section 162 of the shock-absorbing device 90a of FIG. 15. As shown, at least two radially adjacent receiving sections 213 are formed at each of two diametrically opposite sides in the second receiving seat 210 of the shock-absorbing device 90a. Each of the receiving sections 213 has one elastic element 300 received therein. And, the first coupling section 160 includes a fastening section 162, which can be in the form of a male thread, a female thread (see FIG. 16(a)), a post (see FIG. 16(b)), a male retainer (see FIG. 16(c)), or a female retainer (see FIG. 16(d)).

In conclusion, with the first holding member, the second holding member and the elastic element(s), the shock-absorbing device of the present invention functions to protect the first and the second external element against excessive vibration when they are subjected to an external force. Moreover, the device carrier according to the present invention can be used to carry and hold the shock-absorbing device in an organized manner for convenient storage.

The present invention has been described with some preferred embodiments thereof and it is understood that the preferred embodiments are only illustrative and not intended to limit the present invention in any way and many changes and modifications in the described embodiments can be carried out without departing from the scope and the spirit of the invention that is intended to be limited only by the appended claims.

What is claimed is:

1. A shock-absorbing device, comprising:
a first holding member;
a second holding member being movably assembled to the first holding member; and
an elastic element being disposed between the first and the second holding member with two ends of the elastic element pressing against the first and the second holding member, such that an elastic shock-absorbing space is defined between the first and the second holding member by the elastic element;
wherein the first holding member has a first anti-rotation section for interfering with or engaging with a first external element, or the second holding member has a second anti-rotation section for interfering with or engaging with a second external element.

2. The shock-absorbing device as claimed in claim 1, wherein the first anti-rotation section can be provided on an upper side, a lower side, a lateral side, an inner side or an outer side of the first holding member; or, the second anti-rotation section can be provided on an upper side, a lower side, a lateral side, an inner side or an outer side of the second holding member.

3. A shock-absorbing device, comprising:
a first holding member;
a second holding member being movably assembled to the first holding member; and
an elastic element being disposed between the first and the second holding member with two ends of the elastic element pressing against the first and the second holding member, such that an elastic shock-absorbing space is defined between the first and the second holding member by the elastic element;
wherein the first holding member has a third anti-rotation section; or, the second holding member has a fourth anti-rotation section; and the third and the fourth anti-rotation section being movably engaged with or interfered with each other.

4. The shock-absorbing device as claimed in claim 3, wherein the first holding member has a third anti-rotation section and the second holding member has a fourth anti-rotation section; and the third and the fourth anti-rotation section being movably engaged with or interfered with each other to prevent the first holding member and the second holding member from rotating relative to each other.

5. The shock-absorbing device as claimed in claim 3, wherein the third anti-rotation section can be provided on an upper side, a lower side, a lateral side, an inner side or an outer side of the first holding member; or, the fourth anti-rotation section can be provided on an upper side, a lower side, a lateral side, an inner side or an outer side of the second holding member.
